(19) United States
(12) Patent Application Publication
(10) Pub. No.: US 2006/0277715 A1
(43) Pub. Date: Dec. 14, 2006

(54) Luggage truckle

(75) Inventor: Ching-Nan Lin, Shiu Shui Hsiang (TW)

Correspondence Address: TROXELL LAW OFFICE PLLC, SUITE 1404, 5205 LEESBURG PIKE, FALLS CHURCH, VA, 22041, US

(73) Assignee: SHIN GOANG HARDWARE CO., LTD.

(21) Appl. No.: 11/486,314

(22) Filed: Jul. 14, 2006

(30) Foreign Application Priority Data
May 26, 2005 (TW) 094212648

(51) Int. Cl. B60B 33/00

(52) U.S. Cl. 16/22

(57) ABSTRACT

One luggage truckle, two or four sets of moving truckle are installed at bottom of luggage, which is comprised by reel seat and idler wheel, its features are as follows: idler wheel is respectively pivoted at two sides of front of reel seat, and an assistant rotation wheel is also pivoted at central part of front of reel seat, furthermore, one brake device installed between idler wheels at two sides of reel seat can let truckle move forward in the desired direction but not sway about when pushing luggage forward in proper slant angle for a long distance; moreover, user can brake idler wheel of luggage's truckle to stop luggage when taking escalator.

### BACKGROUND OF THE INVENTION

1) Field of the Invention

This invention relates to luggage truckle, which has relation with the common luggage truckle. It aims to let truckles of such luggage move forward steadily but not sway about.

2) Description of the Prior Art

Usually, luggage is often installed two or four sets of truckles at bottom of chest so that it is convenient to let the said luggage stand and move forward. Please refer to FIG. 1 and FIG. 2 for truckle of prior art, which is comprised by reel seat 2 with bearing at upper section (it is the common structure of truckle, this invention will not describe it in detail.) and idler wheel 3. One groove 21 is made at central part of front of reel seat 2 so that idler wheel 3 can be covered into it and pivoted by pivot pin 31; owing to bearing installed, reel seat 2 can rotate to turn luggage during packing, dragging and pulling luggage, and also rolling of idler wheel 3 can move luggage forward.

However, above described truckle comprised by single idler wheel 3 and reel seat 2 has following disadvantages: first of all, due to bearing installed at upper section of reel seat 2, it can rotate freely so that idler wheel 3 can roll accordingly, furthermore, the said truckle has not been designed any direction finding device, so, it may sway about while pushing or pulling luggage forward.

Secondly, because the said truckle has not been designed any direction finding and brake device, user must hold handle of luggage otherwise it might slide away when taking escalator or staying at where floor is not level, so such truckle is required to get improved.

### SUMMARY OF THE INVENTION

This invention is to improve above said defects. Truckle of luggage invented in this invention is comprised by reel seat and idler wheel, its features are as follows: idler wheel is respectively pivoted at two sides of front of reel seat, and an assistant rotation wheel is also pivoted at central part of front of reel seat, furthermore, one brake device installed between idler wheels at two sides of reel seat can let truckle move forward in the desired direction but not sway about when pushing luggage forward in proper slant angle for a long distance; moreover, user can brake idler wheel of luggage's truckle when taking escalator.

### BRIEF DESCRIPTION OF THE DRAWINGS

FIG. 1 is the exploded appearance sketch map of structure of this invention.

FIG. 2 is the exploded appearance sketch map of structure of this invention from another angle.

FIG. 3 is the exploded sketch map of structure of this invention.

FIG. 4 is the exploded combination appearance sketch map of structure of this invention.

FIG. 5-A is operation sketch map of structure of this invention.

FIG. 5-B is operation sketch map of structure of this invention.

FIG. 5-C is operation sketch map of structure of this invention.

FIG. 5-D is operation sketch map of structure of this invention.

FIG. 5-E is operation sketch map of structure of this invention.

FIG. 6-A is operation sketch map of structure of this invention.

FIG. 6-B is operation sketch map of structure of this invention.

FIG. 6-C is operation sketch map of structure of this invention.

FIG. 7-A is operation sketch map of structure of this invention.

FIG. 7-B is operation sketch map of structure of this invention.

FIG. 7-C is operation sketch map of structure of this invention.

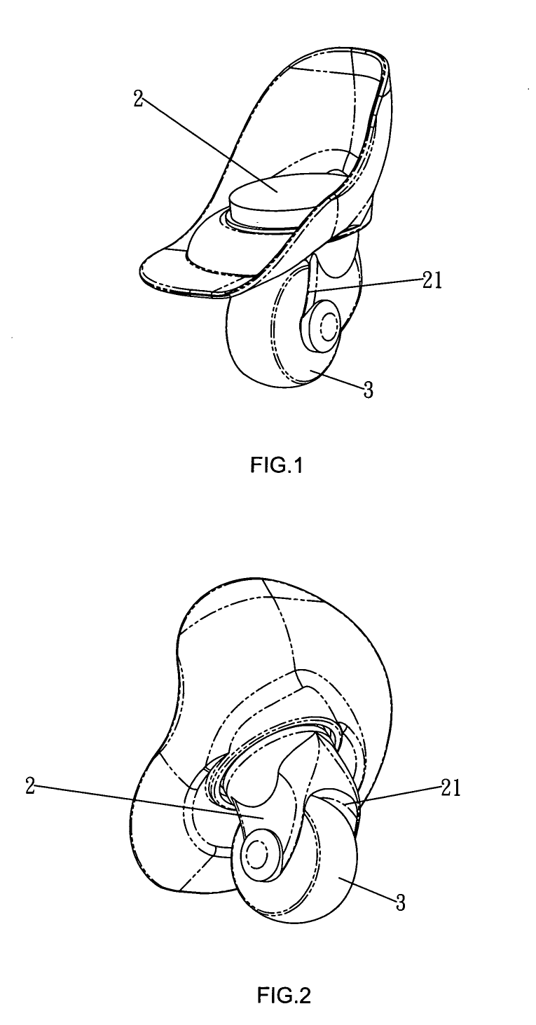

### DETAILED DESCRIPTION OF THE PREFERRED EMBODIMENTS

Features and operations of this invention are described with drawings in the following.

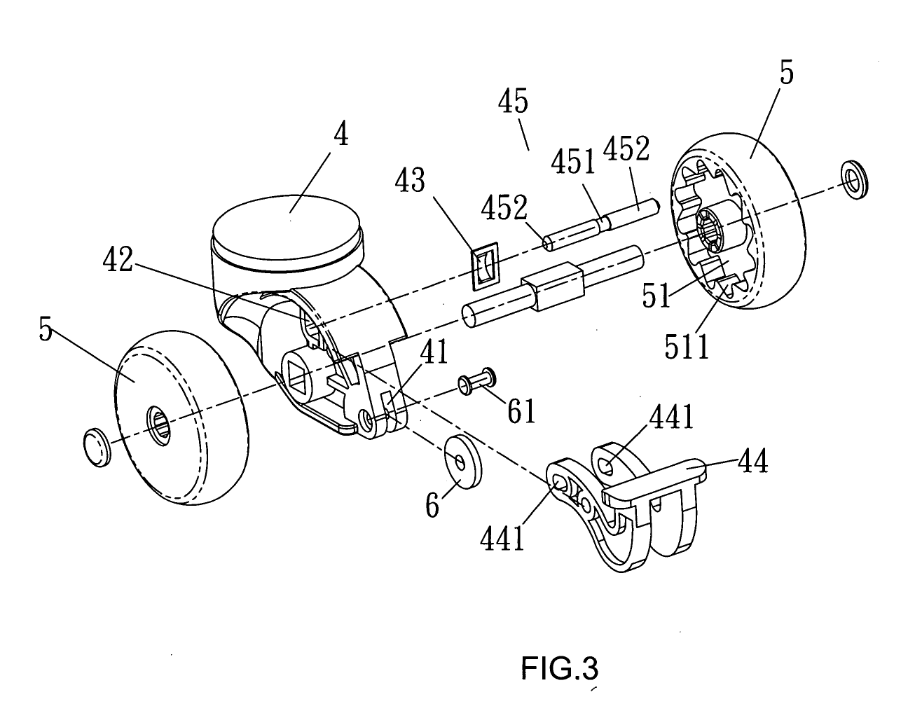

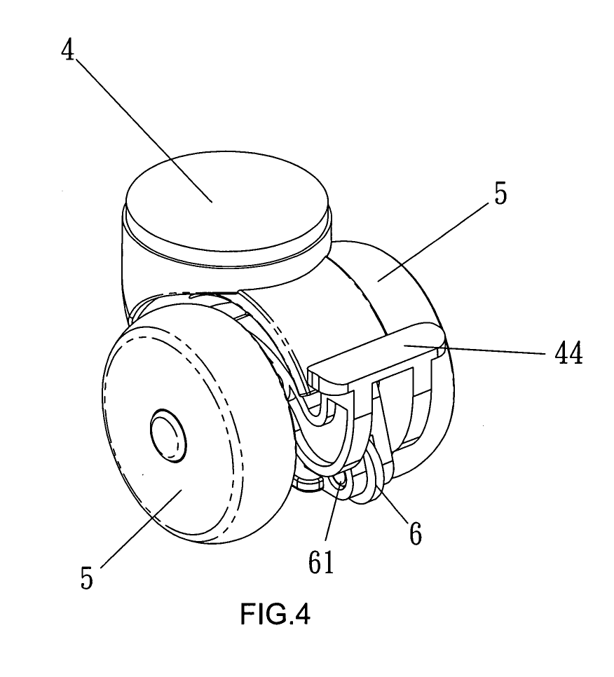

First of all, please refer to FIG. 3 and FIG. 4, luggage truckle of this invention is comprised by reel seat 4 installed bearing inside and idler wheel 5. Its features are as follows: an idler wheel 5 is respectively pivoted at two sides of front of reel seat 4, one groove 41 is fixed at central part of front of reel seat 4 to hold an assistant rotation wheel 6, diameter of assistant rotation wheel 6 is less than idler wheel 5, which is pivoted with pivot pin 61.

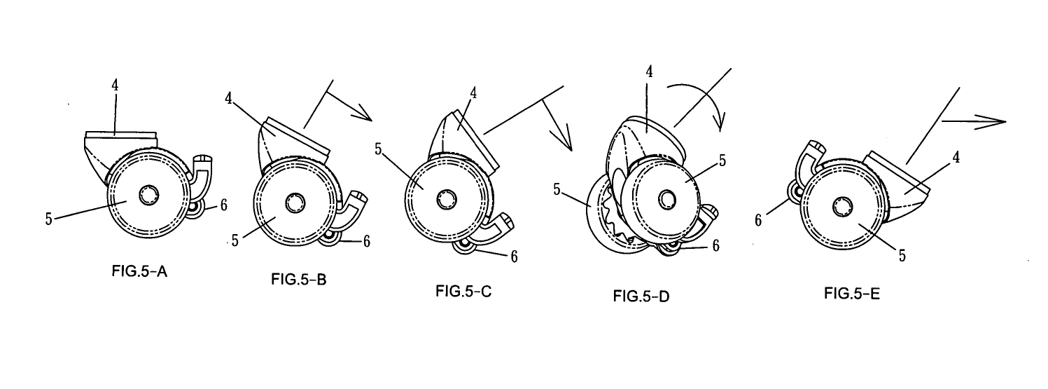

Please refer to FIG. 5-A, FIG. 5-B, FIG. 5-C and FIG. 5-D, owing to idler wheel 5 pivoted at two sides of reel seat 4 of truckle, the said truckle may not swing like the common truckle with single idler wheel 3 while turning and swaying about, therefore, it can move forward in the desired direction steadily; when user wants to push or pull luggage in proper slant angle for a long distance, assistant rotation wheel 6 pivoted at central part of front of reel seat 4 may touch down ground at the same time (as shown in FIG. 5-B). As luggage is pulled at further slant angle, assistant rotation wheel 6 can form a fulcrum (as shown in FIG. 5-C and FIG. 5-D), whole truckle can turn around 180 degree (as shown in FIG. 5-E) by bearing installed at upper section of reel seat 4, so that truckle can keep two sides of reel seat 4 pivoting with an idler wheel 5, therefore, luggage can move forward in the desired direction.

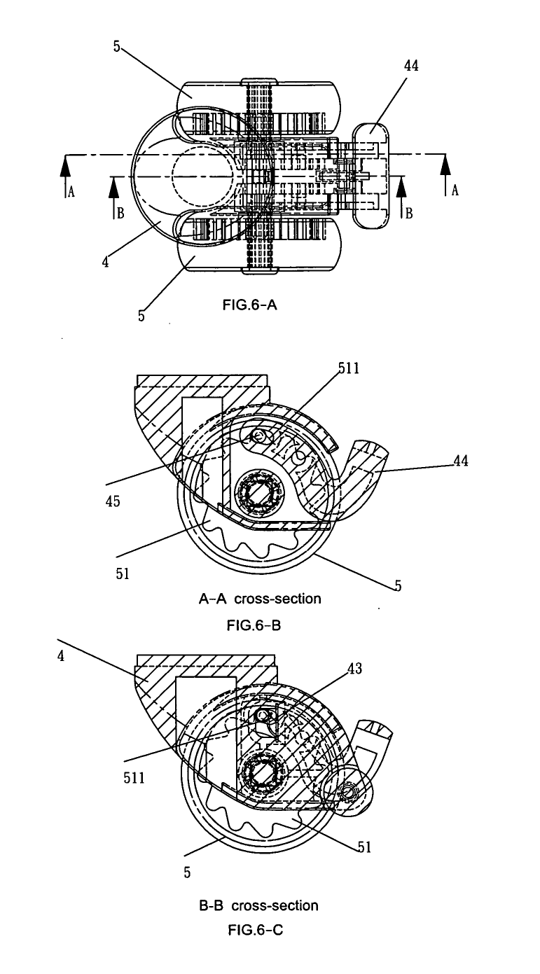

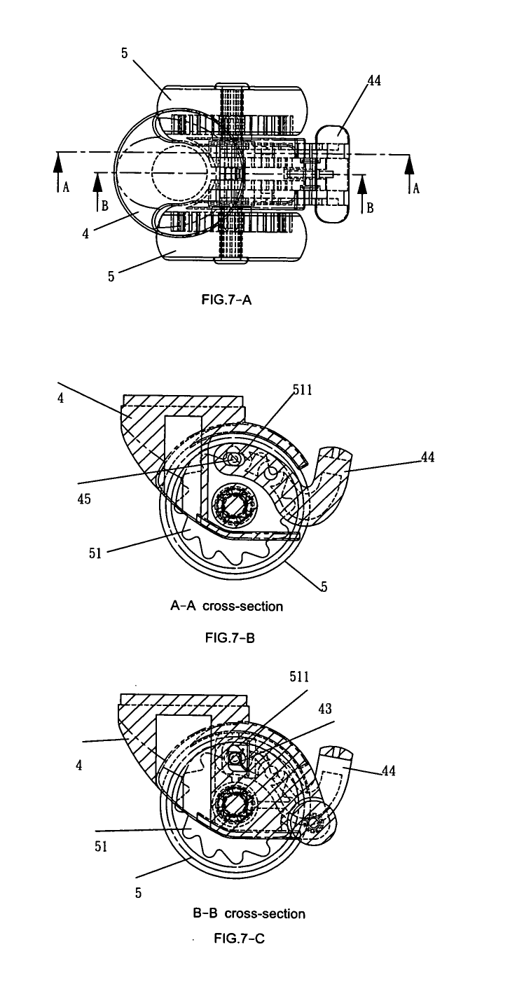

In addition, please refer to FIG. 3, FIG. 4, FIG. 6-A, FIG. 6-B, FIG. 6-C FIG. 7-A, FIG. 7-B and FIG. 7-C; moreover, ratchet ring groove 51 in same shape is respectively assembled at internal rim of idler wheel 5 installed at two sides of reel seat 4, and one position through hole 42 is set at middle section of reel seat 4 in axial direction, sheet metal 43 is covered into position through hole 42, and brake seat 44 covers onto two sides of central part of front of reel seat 4, elliptic through hole 441 is fixed at end of brake seat 44 so that control pin 45 of position ring groove 451 fixing at middle section can pass through the through hole 441 and position through hole 42, two ends 452 of control pin 45 can extend toward ratchet ring groove 51 installed at internal side of idler wheel 5, and sheet metal 43 covered into position through hole 42 can press down position ring groove 451 fixing at middle section so as to brake the said truckle accordingly.

As assembled by above said structures, when taking escalator or staying at where floor is not level, user can press down brake seat 44 in brake device by foot so that sheet metal 43 of position through hole 42 covered into middle section of reel seat 4 can push upward control pin 45; as through hole 441 at end of brake seat 44 to pass through control pin become ellipse, two ends 452 of control pin 45 then enter into tooth space 511 inside ratchet ring groove 51 of idler wheel 5, so that truckle can stop rotating (please see FIG. 6-A, FIG. 6-B and FIG. 6-C); on the contrary, if want to pull or drag luggage again, rotation of idler wheel 5 can force two ends 452 of control pin 45 to drop off tooth space of ratchet ring groove 51, thus, idler wheel 5 can rotate freely once again (please refer to FIG. 7-A, FIG. 7-B and FIG. 7-C).

As described above, this invention is indeed can improve defects of the said product, its efficiency and advantage have never been publicized in any publication up to now, thus, it answers to novelty of new patent.

What is claimed is:

1. One luggage truckle, which is comprised by reel seat installed bearing and idler wheel, its features are as follows: idler wheel is respectively pivoted at two sides of front of reel seat, and one groove is also fixed at central part of front of reel seat so as to place an assistant rotation wheel, diameter of this assistant rotation wheel is less than idler wheel, which is pivoted with pivot pin.

2. As claimed in claim 2, it is luggage truckle, wherein ratchet ring groove in same shape is respectively assembled at internal rim of idler wheel installed at two sides of reel seat, and one position through hole is made at middle section of reel seat in axial direction, sheet metal is covered into position through hole, and brake seat covers onto two sides of central part of front of reel seat 4, elliptic through hole 441 is fixed at end of brake seat so that control pin of position ring groove fixing at middle section can pass through the through hole and position through hole, two ends of control pin can extend toward ratchet ring groove installed at internal side of idler wheel, and sheet metal covered into position through hole can press down position ring groove fixing at middle section so as to brake the said truckle accordingly.
